(19) United States
(12) Patent Application Publication
(10) Pub. No.: US 2020/0168981 A1
(43) Pub. Date: May 28, 2020

(54) ALL TEXITILE H-PLANE SIW HORN ANTENNA WITH A CORRUGATED GROUND FOR MILLIMETER-WAVE WBAN APPLICATIONS

(71) Applicant: INDUSTRY-UNIVERSITY COOPERATION FOUNDATION HANYANG UNIVERSITY, Seoul (KR)

(72) Inventors: Jaehoon CHOI, Seoul (KR); Seongkyu LEE, Seoul (KR); Youngtaek HONG, Seoul (KR); Kyoseung KEUM, Seoul (KR); Jihoon BANG, Seoul (KR)

(73) Assignee: INDUSTRY-UNIVERSITY COOPERATION FOUNDATION HANYANG UNIVERSITY, Seoul (KR)

(21) Appl. No.: 16/230,039

(22) Filed: Dec. 21, 2018

(30) Foreign Application Priority Data
Nov. 26, 2018 (KR) 10-2018-0147328

(51) Int. Cl. H01Q 1/24; H01Q 13/08

(52) U.S. Cl. CPC H01Q 1/245; H01Q 9/16; H01Q 13/08

(57) ABSTRACT

An all textile H-plane SIW horn antenna with a corrugated ground for millimeter-wave WBAN applications is proposed. An all textile H-plane SIW horn antenna with a corrugated ground for millimeter-wave WBAN applications proposed in the present disclosure includes an antenna unit having coaxially fed SIW H-plane aperture and excitating signals to antenna elements, and an extended corrugated ground to reduce a beam tilting issue by being attached to the aperture of the antenna unit.

This application claims the priority benefit of Korean Patent Application No. 10-2018-0147328, filed on Nov. 26, 2018, in the Korean Intellectual Property Office, the disclosure of which is incorporated herein by reference.

### BACKGROUND

### 1. Field of the Invention

The present disclosure relates to an all textile H-plane SIW horn antenna with a corrugated ground for millimeter-wave WBAN applications.

### 2. Description of Related Art

Since an antenna is not designed by considering electromagnetic wave energy excitated to a human body in the existing technology, there is a problem that when using the existing technology, a body of a user may have significantly high body excitation electromagnetic wave energy.

Accordingly, the present disclosure proposes an all textile H-plane SIW horn antenna with a corrugated ground for millimeter-wave WBAN applications.

### SUMMARY

A technical problem to solve in the present disclosure is providing a method and apparatus for extending and corrugating ground on a human body surface to reduce electromagnetic wave energy excitated to a body of a user. A corrugated ground reduces electromagnetic wave energy toward a human body simultaneously with reducing an antenna beam reflecting issue due to the extended ground.

According to at least one example of embodiments, an all textile H-plane SIW horn antenna with a corrugated ground for millimeter-wave WBAN applications proposed in the present disclosure includes an antenna unit having a coaxially fed SIW H-plane aperture and excitating signals to antenna elements, and an extended corrugated ground to reduce a beam tilting issue by being attached to the aperture.

The ground reduces electromagnetic wave energy density in the vertical direction of a human body by applying the extended corrugated ground on the aperture of the antenna unit.

The ground reduces a beam tilting issue by applying a conductor wall to the extended corrugated ground.

The antenna unit excitates signals to each of antenna elements by using a coaxial feed port.

The ground is implemented with conductive thread with a predetermined height.

The antenna unit is implemented with a Via of TSHA (Traditional SIW H-plane horn Antenna) implemented with conductive thread with a predetermined height.

According to example embodiments, electromagnetic wave energy excitated to a human body may be reduced by providing a method and apparatus for extending and corrugating ground on a human body surface. The corrugated ground may reduce electromagnetic wave energy toward a human body simultaneously with reducing an antenna beam reflecting issue due to the extended ground.

### BRIEF DESCRIPTION OF THE DRAWINGS

These and/or other aspects, features, and advantages of the present disclosure will become apparent and more readily appreciated from the following description of embodiments, taken in conjunction with the accompanying drawings of which:

FIG. 1 is a schematic diagram illustrating an all textile H-plane SIW horn antenna with a corrugated ground for millimeter-wave WBAN applications according to an example of embodiments;

FIG. 2 is a graph illustrating antenna property changes according to the number of conductor walls of an extended corrugated ground according to an example of embodiments;

FIG. 3(A) is a graph illustrating return loss.

FIG. 3(B) is a graph illustrating gain on yz plane.

FIG. 3(C) is a graph illustrating gain on xy plane.

FIG. 4 is a graph illustrating comparison of energy density excitated toward a human body in case of applying an extended corrugated ground according to an example of embodiments;

FIG. 5 is a picture of a trial product of an antenna according to an example of embodiments;

FIG. 6(A) is a graph illustrating return loss.

FIG. 6(B) is a comparison graph of simulation and measurement result of beam pattern of an antenna according to an example of embodiments.

FIG. 6(C) is a comparison graph of simulation and measurement result of beam pattern of an antenna according to another example of embodiments.

### DETAILED DESCRIPTION

The example embodiment of the present disclosure proposes a corrugated ground for reducing power density and proposes an antenna having human body surface-directed beam of 28 GHz for 5G wireless applications wearable to a human body. Hereinafter, some example embodiments will be described in detail with reference to the accompanying drawings.

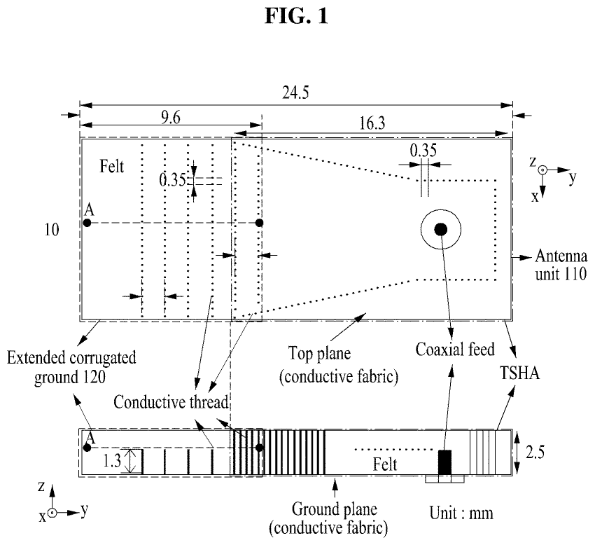

FIG. 1 is a schematic diagram illustrating an all textile H-plane SIW horn antenna with a corrugated ground for millimeter-wave WBAN applications according to an example of embodiments.

The present disclosure proposes a method for extending ground of a human body surface and corrugating the ground to reduce electromagnetic wave energy excitated to a body of a user. The corrugated ground may reduce electromagnetic wave energy toward a human body simultaneously with reducing an antenna beam issue due to the extended ground.

The proposed all textile H-plane SIW horn antenna with a corrugated ground for millimeter-wave WBAN applications has an antenna unit 110 having a coaxially fed SIW H-plane aperture and excitating signals to antenna elements, and an extended corrugated ground 120 to reduce a beam tilting issue by being attached to the aperture.

The ground 120 may reduce electromagnetic wave energy density in the vertical direction of a human body by applying the extended corrugated ground on the aperture of the antenna unit, and reduce a beam tilting issue by applying conductor wall to the extended corrugated ground. The ground 120 may be implemented with conductive thread with a predetermined height. For example, the ground 120 may be implemented with conductive thread with 1.3 mm height.

The antenna unit 110 excitates signal to each of antenna elements by using a coaxial feed port. The antenna unit 110 is implemented with a Via of TSHA (Traditional SIW H-plane horn Antenna) implemented with conductive thread with a predetermined height. For example, it may be implemented with conductive thread with 2.5 mm height.

Structure of an all textile antenna wearable to a human body according to an example of embodiments consists of a general coaxially fed SIW H-plane aperture antenna and an extended corrugated ground. An exemplary size of the all textile antenna used in the present disclosure may be 24.5×10×2.5 mm 3.

Corrugated side of an extended corrugated ground according to an example of embodiments may be implemented with conductive thread with 1.3 mm height, and a Via of TSHA (Traditional SIW H-plane horn Antenna) may be implemented with conductive thread with 2.5 mm height.

A signal is excitated to each of antenna elements by using a coaxial feed port. Also, simulation result is achieved by using finite element method based HFSS software.

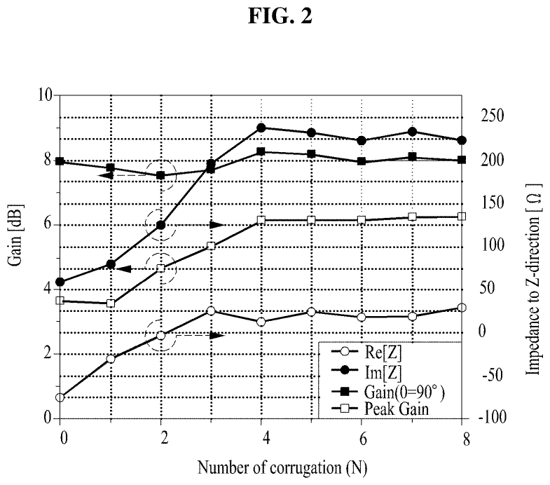

FIG. 2 is a graph illustrating antenna property changes according to the number of conductor walls of an extended corrugated ground according to an example of embodiments.

As FIG. 2, as the number of conductor walls increases, real part of wave impedance on the extended corrugated ground closes to 0 and value of imaginary part increases.

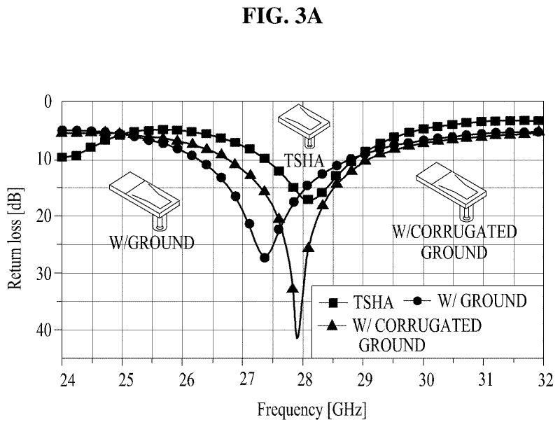

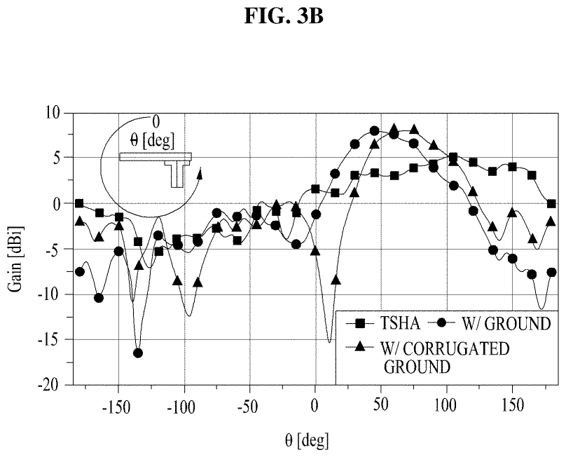

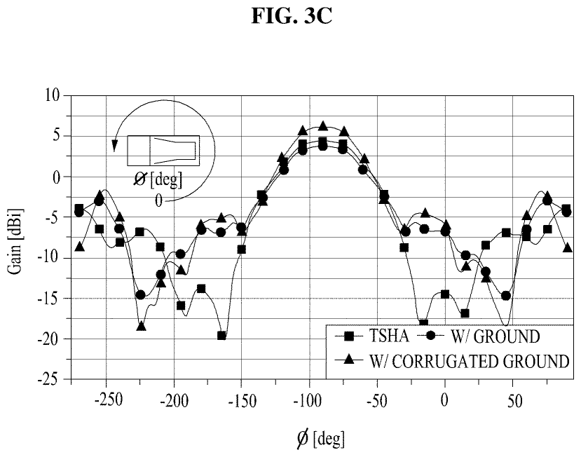

FIG. 3 is a graph illustrating performance comparison of a general antenna and an antenna applying a proposed structure according to an example of embodiments.

FIG. 3(A) is a graph illustrating return loss, FIG. 3(B) is a graph illustrating gain on yz plane, and FIG. 3(C) is a graph illustrating gain on xy plane.

As shown in FIG. 3, when comparing antenna performance changes of applying a simple extended ground to an aperture of TSHA and applying an extended corrugated ground to an aperture of TSHA, return loss property is lower than −10 dB at 28 Hz. In case of an antenna applied with a general extended ground, it is shown that beam is tilted in the opposite direction of the extended ground at 28 GHz because of the extended ground. It may be confirmed that the antenna applied with an extended corrugated ground reduces a beam tilting issue because of the ground.

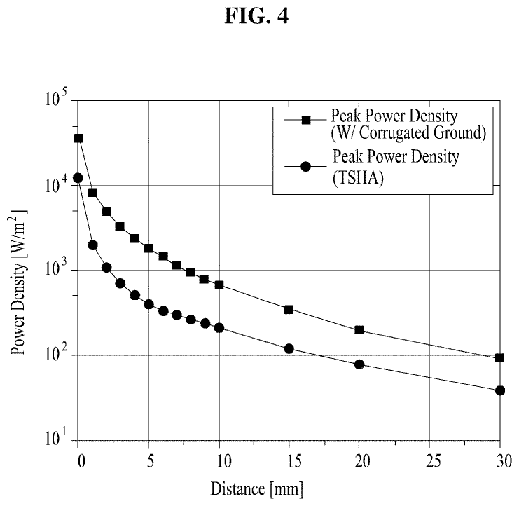

FIG. 4 is a graph illustrating comparison of energy density excitated toward a human body in case of applying an extended corrugated ground according to an example of embodiments.

Referring to FIG. 4, when inputting 1 W on an antenna, it is indicated the maximum electromagnetic energy excitated to 40 mm×80 mm rectangle surface. A value when there is 0 to 30 mm interval toward a human body surface from an antenna ground is calculated by using CST software. It may be confirmed that when 5 mm away from an antenna ground, amount of energy excitation has a value of 78% reduced of the amount of electromagnetic wave energy excitated to a human body by using a structure proposed with 401.56 W/m² on applying the extended corrugated ground and 1808.23 W/m² without applying the extended corrugated ground.

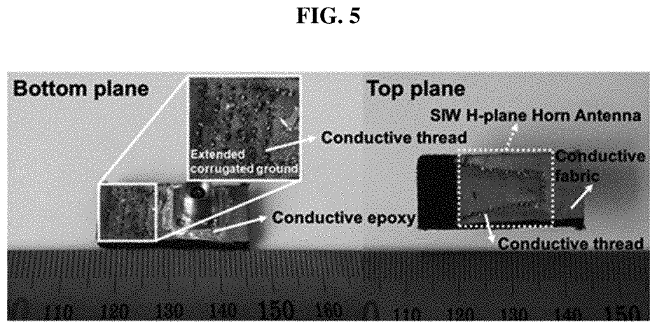

FIG. 5 is a picture of a trial product of an antenna according to an example of embodiments.

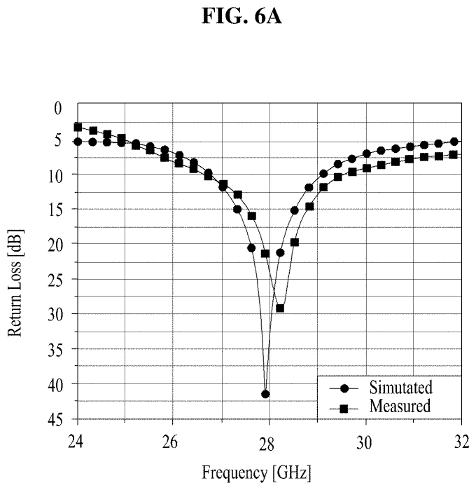

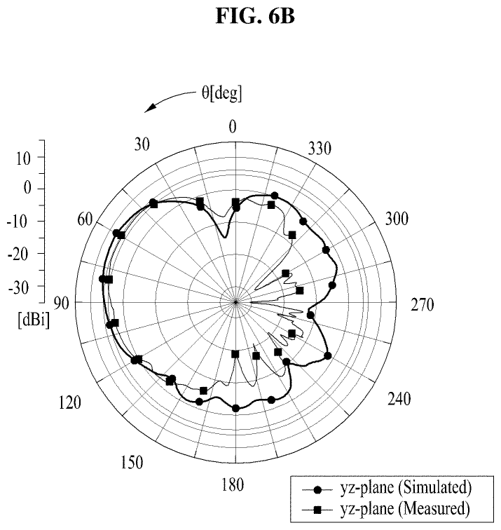

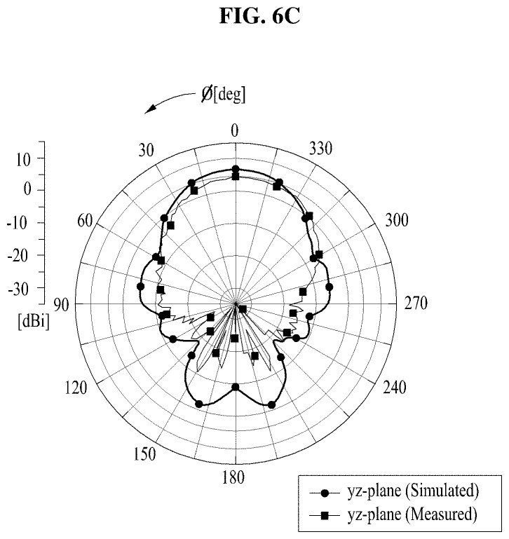

FIG. 6 is a graph illustrating return loss and a comparison graph of simulation and measurement result of beam pattern of an antenna according to embodiments.

FIG. 6(A) is a graph illustrating return loss.

FIG. 6(B) is a comparison graph of simulation and measurement result of beam pattern of an antenna according to an example of embodiments.

FIG. 6(C) is a comparison graph of simulation and measurement result of beam pattern of an antenna according to another example of embodiments.

A proposed all textile H-plane SIW horn antenna with a corrugated ground for millimeter-wave WBAN applications may be applied to millimeter-wave WBAN applications, and by providing a method and apparatus for extending a ground on a human body surface and corrugating the ground, electromagnetic wave energy excitated toward a human body may be reduced. Also, the corrugated ground may reduce electromagnetic energy toward a human body simultaneously with reducing an antenna beam reflection issue.

The units described herein may be implemented using hardware components, software components, and/or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present disclosure, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

While certain example embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. An textile antenna comprising:
an antenna unit having a coaxially fed SIW H-plane aperture, and excitating signals to antenna elements; and
an extended corrugated ground to reduce a beam tilting issue by being attached to the aperture.

2. The textile antenna of claim 1, wherein the ground reduces electromagnetic wave energy density in vertical direction of a human body by applying the extended corrugated ground on the aperture of the antenna unit.

3. The textile antenna of claim 1, wherein the ground reduces a beam tilting issue by applying a conductor wall to the extended corrugated ground.

4. The textile antenna of claim 1, wherein the antenna unit excitates signals to each of antenna elements by using a coaxial feed port.

5. The textile antenna of claim 1, wherein the ground is implemented with conductive thread with a predetermined height.

6. The textile antenna of claim 1, wherein the antenna unit is implemented with a Via of TSHA (Traditional SIW H-plane horn Antenna) implemented with conductive thread with a predetermined height.
